(19) United States
(12) Patent Application Publication
(10) Pub. No.: US 2007/0059487 A1
(43) Pub. Date: Mar. 15, 2007

(54) TRIM PANEL WITH INSERT MOLDED DECORATIVE COMPONENT

(75) Inventors: David J. Dooley, Troy, MI (US); Randy S. Reed, Fair Haven, MI (US); Glenn Cowelchuk, Chesterfield Township, MI (US); Todd L. DePue, Brighton, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/162,579

(22) Filed: Sep. 15, 2005

(51) Int. Cl. B32B 3/10; B29C 45/14

(52) U.S. Cl. 428/137; 264/259; 264/273

(57) ABSTRACT

In at least certain embodiments, the present invention relates to an automobile trim panel with an insert molded decorative component. In at least one embodiment, the automobile interior panel is made by a) providing a molding tool comprising a first mold half and a second mold half that cooperate to form a first mold cavity, b) providing an insert component within the first mold cavity having a substrate made of a first material, and a decorative portion made of a second material less rigid that the first material, with the first mold half, the second mold half, and the insert component forming a second mold cavity, and c) introducing a resin into the second mold cavity to form a panel secured to the insert component.

### BACKGROUND OF THE INVENTION

1. Field of the Invention

The present invention is related to a trim panel with insert molded decorative component made by injection molding.

2. Background Art

Motor vehicle interiors have many interior components made of trim panels. Examples of these types of interior components include, but are not necessarily limited to, interior trim panels, interior door panels, knee bolsters, instrument panels, consoles, and other interior trim parts.

Some interior trim panels, such as interior door panels and glove box covers, to name a few, comprise a rigid door panel substrate and a relatively soft bolster portion. Some bolsters are formed of a relatively rigid substrate with a cover over at least a portion if not all of the upper surface of the bolster substrate. In some instances, a foam layer can be provided between the upper layer of the cover and bolster substrate.

Typically, the bolster and the rigid door panel substrate are formed separately with the bolster being heat staked or attached via other suitable attachment mechanisms to the door panel substrate. Such a manufacturing process requires a secondary operation of heat staking. Also, due to the inherent give between heat staked bolster and the door substrate, rattling and squeaking can occur during operation of the vehicle. Also, uneven gaps from manufacturing variation can occur.

Accordingly, it would be desirable to provide a trim panel having a bolster or other added component which would overcome at least one of the deficiencies in the prior art, such as requiring the use of heat staking or undesirable rattling.

### SUMMARY OF THE INVENTION

According to one aspect of the present invention, a method making an automobile interior panel is provided. In at least one embodiment, the method comprises a) providing a molding tool comprising a first mold half and a second mold half, with the first and second mold halves cooperating to form a first mold cavity, b) providing an insert component within the first mold cavity, with the insert component having a substrate made of a first material and a decorative portion made of a second material less rigid than the first material, with the first mold half, the second mold half, and the insert component forming a second mold cavity, and c) introducing a resin into the second mold cavity, wherein the resin, upon cooling, forms a panel secured to the insert component.

In at least one embodiment of the present invention, the substrate of the insert component includes a plurality of holes. In at least another embodiment of the present invention, the holes are oval-shaped. In at least yet another embodiment of the present invention, the holes have an inwardly-extending angled surface.

In at least yet another embodiment of the present invention, the panel has a plurality of transverse projections extending through the holes in the insert component. In still yet at least another embodiment of the present invention, the holes are configured to allow radial movement of the projections as the resin cools to form the panel. In yet another embodiment of the present invention, the projections have at least one outwardly-extending angled surface.

In at least yet another embodiment of the present invention, the panel contacts the substrate. In still yet at least another embodiment of the present invention, the panel comprises a third material that does not bond to the first material. In still yet another embodiment of the present invention, the third material is different from the first material. In yet a further embodiment of the present invention, the second material comprises a thermoplastic resin or a fabric material, such as cloth or leather.

According to another aspect of the present invention, an automobile interior panel is provided. In at least one embodiment, the automobile interior panel is made in accordance with the method described above.

According to yet another aspect of the present invention, an automobile door panel is provided. In at least one embodiment, the automobile door panel is made in accordance with the method described above.

In yet another embodiment, the method of making an interior panel comprises a) providing a molding tool having a first mold cavity, b) providing a decorative insert component within the first mold cavity, with the insert component having a substrate made of a first material and a cover portion extending over at least a portion of the substrate, with the cover portion being made of a second material less rigid that the first material. In this embodiment, the first mold half, the second mold half, and the insert component form a second mold cavity, with the insert component having holes extending through the substrate and the cover portion. This embodiment further comprises introducing a resin into the second mold cavity to form a panel secured to the insert component, wherein the panel has transverse projections extending through the holes in the insert component to help secure the insert component to the panel.

In yet another embodiment, an automobile interior panel is provided comprising a main panel made of a first rigid plastic material, a decorative component secured to the main panel, with the decorative component having a substrate made of a second rigid plastic material and a decorative portion made of a third material, and with the third material being less rigid that the first and second materials and the first material being different than the second material, the decorative component having a plurality of oval-shaped holes, and the main panel having a plurality of projections, with each one of the projections extending through a respective one of the holes to help secure the decorative component to the main panel.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is an idealized side view of an automobile interior panel made by the method of the invention;

FIG. 2 is a fragmentary sectional view of the automobile interior panel shown in FIG. 1, taken through line 2-2;

FIG. 3 is a view of a mold half carrying a component of the automobile interior panel shown in FIG. 1;

FIG. 4 illustrates a top view of the component illustrated in FIG. 3;

FIG. 5 is an illustration of a second mold half cooperating with the first mold half and the component to form a second mold cavity;

FIG. 6 is a view similar to FIG. 5 showing the introduction of resin into the first mold cavity;

FIG. 7 is a view similar to FIG. 6 showing the finished interior panel of FIG. 1;

FIG. 8 is a fragmentary sectional view of a portion of the instrument panel shown in FIG. 7 taken along the line 8-8; and

FIG. 9 is a view similar to FIG. 8 with the instrument panel removed from the molding tool.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily of scale, some features may be exaggerated or minimized to show details of particular components. Therefore specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable preferred for a given purpose in connection with the invention implies that mixtures of any two or more members of the group or class may be equally suitable or preferred.

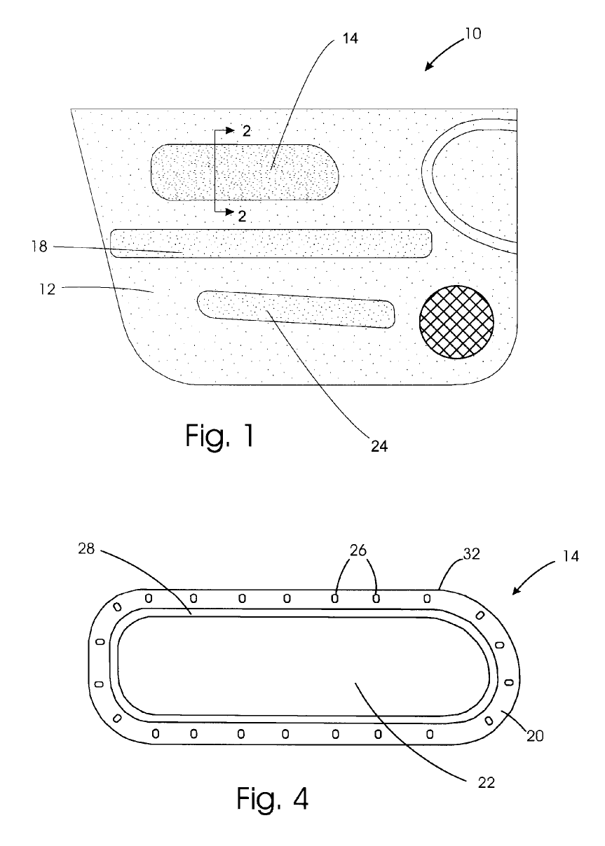

FIG. 1 shows an interior vehicle trim panel, such as an interior door panel 10 in accordance with at least one aspect of the invention. Certain aspects of the present invention will be described below in connection with the door panel 10. However, it should be understood that other trim products, such as instrument panels, glove box door covers, console sides, console covers, pillar trim panels, shelves, trim covers and the like can also enjoy the benefits of the present invention.

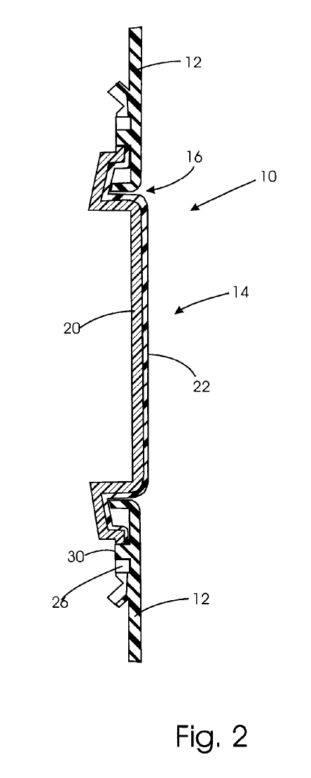

Referring to FIGS. 1 and 2, door panel 10 includes a main panel 12 which may also include additional structures attached thereto. The door panel 10 also includes a bolster 14 attached thereto. The major panel 12 is made of plastic material and includes an opening 16 (FIG. 2). The bolster 14 when attached to the major panel 12 covers the opening 16 (FIG. 2). Referring again to FIG. 1, Door panel 10 can also include additional components such as an armrest 18 and a map pocket 24.

With reference to FIGS. 2, 3 and 4, bolster 14 in the illustrated embodiment can include a bolster substrate 20 and a cover layer 22 attached to the bolster substrate 20. While bolster cover 22 is shown in the figures to cover the entire upper surface of bolster substrate 20, it should be understood that bolster cover 22 can cover less than the entire upper surface of the bolster substrate 20. Bolster 14 also includes a plurality of spaced apart holes 26 and an annular channel 28 spaced radially inward of the holes. The holes 26, as will be explained further below, help facilitate attachment of the bolster 14 to the major panel 12 of the door panel 10.

Major panel 12 includes projections 30 shown schematically in FIG. 2, that extend through holes 26 to help secure the bolster 14 to the major panel 12.

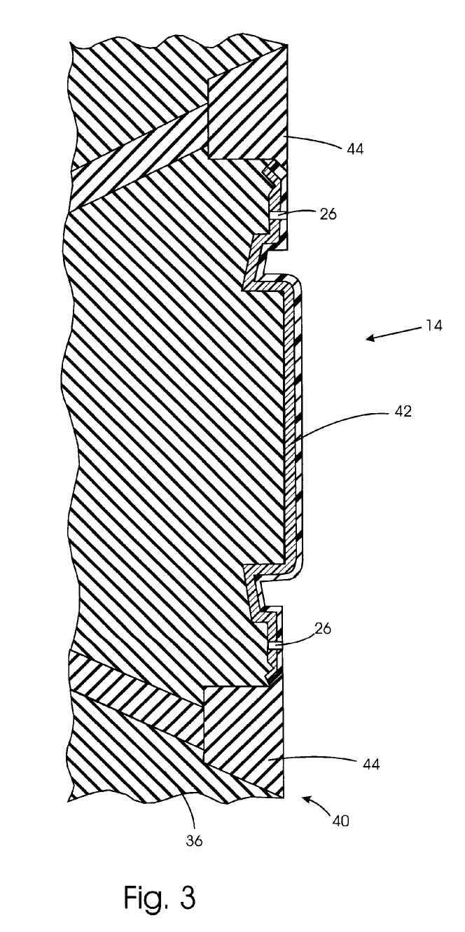

Referring to FIG. 3, a method of making a door panel 10 in accordance with the present invention will be described. FIG. 3 illustrates a core half 36 of a mold tool 40. The core half 36 has a surface 42 for receipt of the bolster 14. In the embodiment illustrated, the mold tool 40 provide moveable lifters 44 to help hold the bolster 14 in place during molding of the major panel 12. In other embodiments, a vacuum could be used in place of or in addition to the lifters 44.

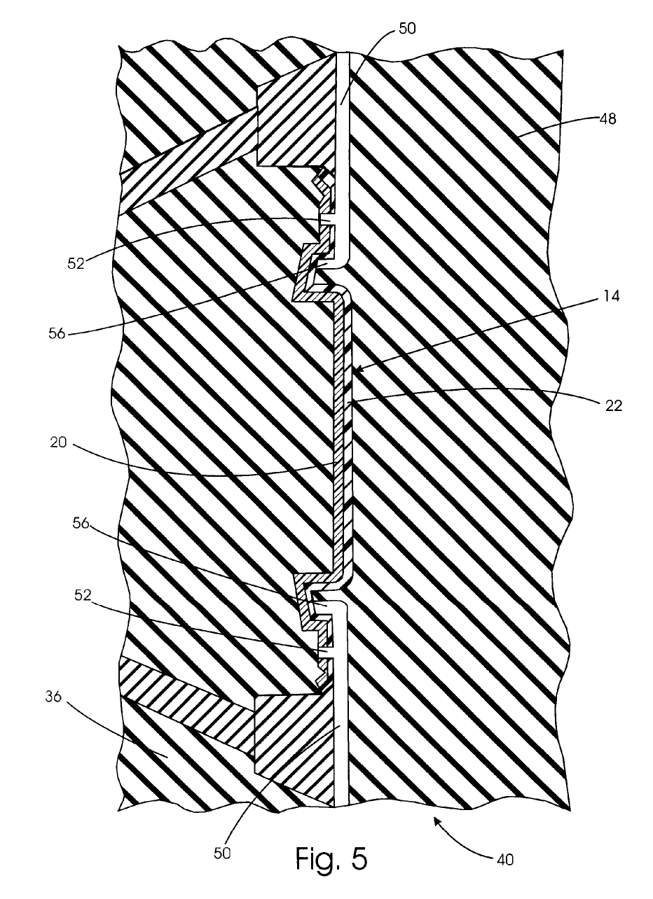

As best shown in FIG. 4, the bolster holes 26 are oval-shaped. The oval-shaped holes 26 extend radially inward from an outer perimeter edge 32 of the bolster 14 towards the center of the bolster.

Referring to FIG. 5, the mold tool 40 includes a cavity half 48. As shown in FIG. 5, when mold tool is closed (i.e. core half 36 and cavity half 48 are brought together to contact the bolster 14), a cavity 50 is formed within the mold tool 40). In the illustrated embodiment, the cavity 50 has a plurality of spaced apart finger portions 52 that extends into a respective one of the hole 26 of the bolster 14 and an edge portion 56, spaced radially inward of the first finger portions. In the illustrated embodiment, each of the first finger portions 52 have a diameter less than the radial length and essentially equal to the circumferential length (perpendicular to the radial length) of each of the holes 26. The edge portion 56, in the illustrated embodiment, is received within the channel 28 of the bolster 14.

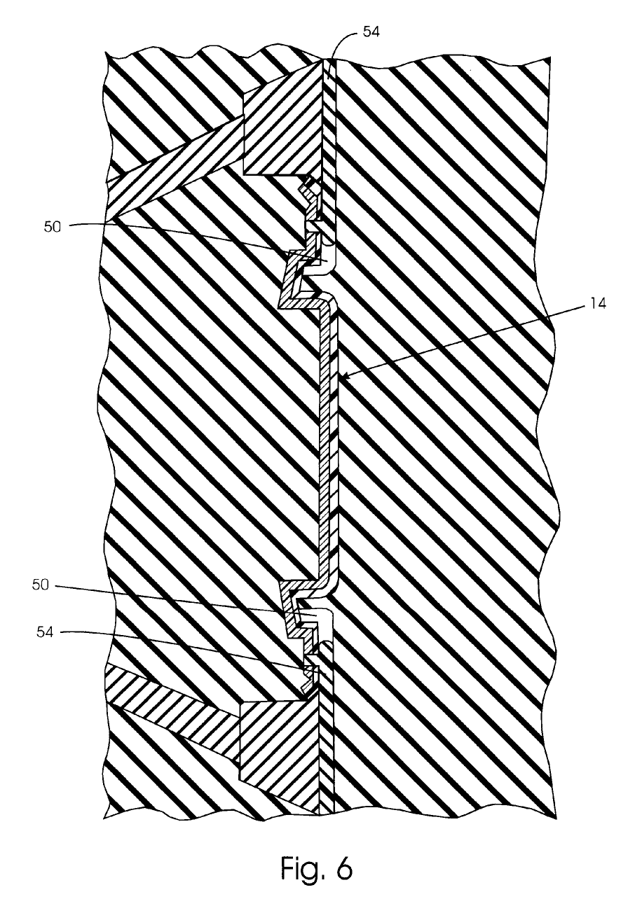

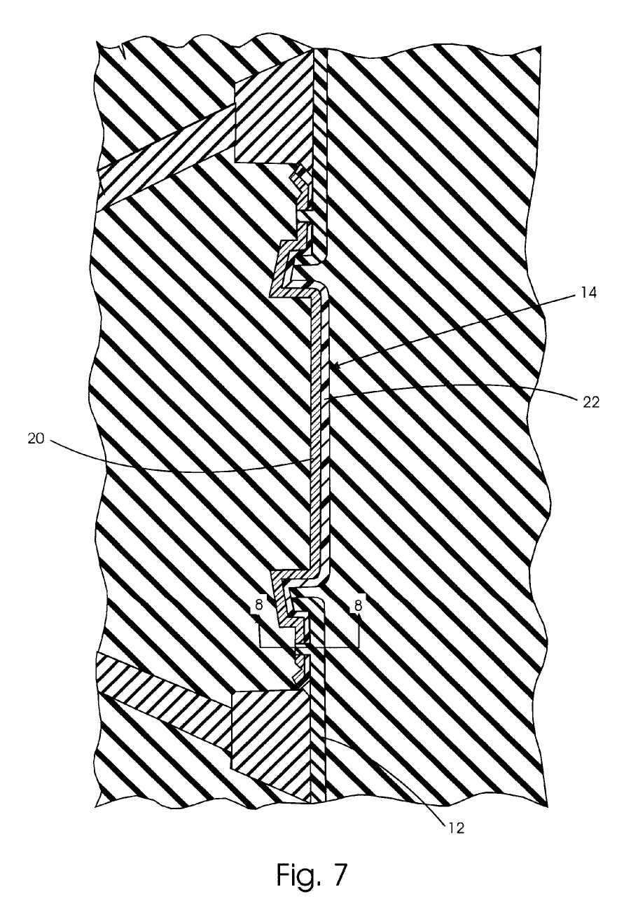

Next, referring to FIG. 6, resin 54 is introduced into the mold cavity 50. The resin 54 flows through the mold cavity 50, as shown in FIG. 7, filling the mold cavity 50 including the finger portions 52 and the edge portion 56. The resin 54 upon cooling, or curing, form door panel 12, as shown in FIG. 2. The resin that cools in the finger portions 52 form the projections 30.

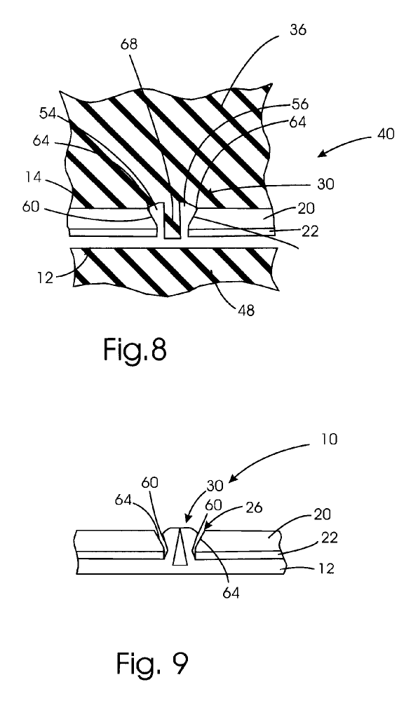

Referring to FIG. 8, a closeup sectional view of the projection 30 while in the mold 40 is shown. As best shown in FIG. 8, each of the projections 30 on the door panel 12 extend through a respective one of the holes 26 in the bolster 14. In the illustrated embodiment, each of the projections 30 includes a first leg 54 and a second leg 56 spaced from the first leg 54. The second core half 36 has a plurality of nose portions 68 to help form legs 54 and 56. As shown in the embodiment illustrated in FIG. 8, each of the legs 54 and 56 have an angled surface 60. The angled surface 60 of each leg 54 and 56 extend outwardly.

Still referring to FIG. 8, the holes 26 of bolster 14 include inwardly angled surfaces 64 that correspond to angled surfaces 60. In the illustrated embodiment, during molding, the cover surface 22 of the bolster 14 compresses. As the door panel 10 is removed from the mold 40, as can be seen in FIG. 9, the cover surface 22 of the bolster 14 expands to its natural and desired state. In at least one embodiment, cover 22 could include a skin layer and a foam layer. The expansion of the cover layer 22 causes the projections 30 to move axially down their respective holes 26. The angled surfaces 60 and 64 allow such axial movement and also helps to prevent the projections 30 from pulling out of their respective holes 26 because the total thickness of each of the projections is greater than the width of their respective hole.

Referring to FIG. 4, a top view of the bolster 14 is illustrated and shows the holes 26 to be oval. As best seen when comparing FIG. 7 to FIG. 2, the holes 26 of the bolster 14 being oval allow radial movement of the major panel 12 about the bolster 14 during cooling of the resin that forms the major panel 12. The configuration of the channel 28, being larger in radial length than the edge portion 56, also allows the radial movement of the major panel 12. This provides room for the main panel 12 to shrink around the bolster 14 without causing substantial stress on the bolster 14 of the panel 12. Also, in certain embodiments, the plastic material that forms the substrate 20 is different from the plastic material that forms panel 12 to help ensure that they will not bond to each other. This also helps to enable the radial movement.

The major panel 12 can be made of any suitable plastic material such as a relatively hard, relatively rigid resinous material like polypropylene, filled polypropylene, polyethylene, TPO, PC (Polycarbonate), PC/ABS, ABS and SMA. The bolster substrate 20 can also can be made of any suitable plastic material such as a relatively hard, relatively rigid resinous material like polypropylene, filled polypropylene, polyethylene, TPO, PC (Polycarbonate), PC/ABS, ABS and SMA. In at least certain embodiments, the major panel 12 and the bolster substrate 20 are made of different materials to help ensure that the major panel 12 and bolster substrate 20 do not bond to each other. The bolster cover 22 can be made of any suitable relatively non-rigid relatively soft skin layer material such as TPE, TEE, EPDM, any other suitable elastomeric materials, or a fabric material such as cloth, vinyl, or leather. The bolster cover 22 is typically made of a material that will have a rebound force so that the bolster cover can compress during molding (FIG. 8) and expand after the molding. In some instances, the cover 14 will comprise a layer of foam (polyurethane, polypropylene, polyethylene, etc.) between the skin layer and the bolster substrate 20.

While embodiments of the invention have been illustrated and described, it is not intended that these embodiments illustrate and describe all possible forms of the invention. For instance, the holes 16 can be shaped differently than oval, such as rectangular, so long as the holes are longer in one direction than their respective projection but shorter in another direction to allow relative radial movement between major panel 12 and bolster 14 during formation of the panel 12. Also, components other than, or in addition to, the bolster 14 can be attached to the major panel 12 employing the teachings of the present invention. Rather, the words used in the specification are words of description rather than limitation, and it is understood that various changes may be made without departing from the spirit and scope of the invention.

What is claimed is:

1. A method of making an automobile interior panel, said method comprising:
a) providing a molding tool comprising a first mold half and a second mold half, the first and second mold halves cooperating to form a first mold cavity;
b) providing an insert component within the first mold cavity, the insert component having a substrate made of a first material and a decorative portion made of a second material, the second material being less rigid that the first material, the first mold half, the second mold half, and the insert component forming a second mold cavity; and
c) introducing a resin into the second mold cavity, the resin, upon cooling, forming a panel secured to the insert component.

2. The method of claim 2 wherein the substrate of the insert component includes a plurality of holes.

3. The method of claim 2 wherein the panel has a plurality of transverse projections extending through the holes in the substrate to help secure the insert component to the panel.

4. The method of claim 3 wherein the holes are configured to allow radial movement of the projections as the resin cools to form the panel.

5. The method of claim 4 wherein the holes are oval-shaped.

6. The method of claim 3 wherein the holes have an inwardly-extending angled surface.

7. The method of claim 6 wherein the projections have at least one outwardly-extending angled surface.

8. The method of claim 1 wherein the panel contacts the substrate.

9. The method of claim 8 wherein the panel comprises a third material, the third material does not bond to the first material.

10. The method of claim 9 wherein the third material is different from the first material.

11. The method of claim 1 wherein the second material comprises a thermoplastic resin or a fabric material.

12. An automobile interior panel made by the method of claim 1.

13. An automobile door panel made by the method of claim 1.

14. A method of making an automobile interior panel, said method comprising:
a) providing a molding tool having a first mold cavity;
b) providing a decorative insert component within the first mold cavity, the insert component having a substrate made of a first material and a cover portion extending over at least a portion of the substrate, the cover portion being made of a second material less rigid that the first material, the first mold half, the second mold half, and the insert component forming a second mold cavity, the insert component having holes extending through the substrate and the cover portion; and
c) introducing a resin into the second mold cavity, the resin, upon cooling, forming a panel secured to the insert component, the panel having transverse projections extending through the holes in the insert component to help secure the insert component to the panel.

15. The method of claim 14 wherein the holes are oval-shaped.

16. The method of claim 15 wherein the holes have an inwardly-extending angled surface.

17. The method of claim 16 wherein the projections have at least one outwardly-extending angled surface.

18. An automobile interior panel made by the method of claim 17.

19. An automobile door panel made by the method of claim 17.

20. An automobile interior panel comprising:
a main panel made of a first rigid plastic material;
a decorative component secured to the main panel, the decorative component having a substrate made of a second rigid plastic material and a decorative portion made of a third material, the third material being less rigid that the first and second materials and the first material being different than the second material;
the decorative component having a plurality of oval-shaped holes; and
the main panel having a plurality of projections, each of the projections extending through a respective one of the holes to help secure the decorative component to the main panel.
